(19) United States
(12) Patent Application Publication
(10) Pub. No.: US 2009/0320741 A1
(43) Pub. Date: Dec. 31, 2009

(54) Temperature Indicating Device to be Used in Beverage Holding Containers, and, the Containers

(76) Inventor: Jacques Pontes, Sao Paulo (BR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/302,315

(22) PCT Filed: Apr. 11, 2008
(86) PCT No.: PCT/BR2008/000102

§ 371 Date: Jul. 1, 2009

(30) Foreign Application Priority Data
Apr. 23, 2007 (BR) MU 8700751-7
Apr. 23, 2007 (BR) MU 8702175-7

(51) Int. Cl. G01K 1/02; G01D 21/00

(52) U.S. Cl. 116/207; 116/216

(57) ABSTRACT

It is described hereby a temperature indicator device (1), to be used on containers holding beverage, preferably metallic cans, composed of a thermo sensitive and/or biodegradable material.

This invention refers to a temperature indicating device, particularly developed to be used in beverage holding containers, such as aluminum cans, among others.

Besides indicating the temperature, the device has concomitantly protective effects, preventing the contamination of the upper section of the can, as well as a broken seal indicator.

### DESCRIPTION ON THE STATE OF THE TECHNIQUE

Today, consumers have at their disposition hundreds of different beverage available for consumption in aluminum and stainless steel cans, which are practical packages, easy to open and most importantly of all, effective and viable recycling.

Recently, there has been an increase in the number of products available in cans and, if in the past the offer was limited to sodas and beers, currently one may even find energy drinks, various juices, teas, vodkas, wines, water, isotonic beverages, etc. This increase in the number of products available in tins makes this type of market very attractive, as it moves vast sums of money.

Some beverages, such as beer, should be consumed at a certain temperature, because taste and texture can change and, in order to prevent that some refrigerators that hold beers have a digital thermometer on the door, which indicates the temperature inside the refrigerator. Depending on the given temperature, consumer will know if the beer is at the correct temperature. In fact, thermometers become a ‘certifier’ with regards to temperature and the consumer knows if the product is suitable for consumption.

Nevertheless, if the refrigerator does not have a thermometer, there is no other means to know if the beverage is at the correct temperature other than holding the can in hand and estimate the temperature. Evidently the results are inaccurate several times.

Until now, there has been no device developed and added to the can that could in a precise and unequivocal manner indicate if the beverage was at the ideal consumption temperature.

On the other hand, it is notoriously known the possibility of contamination of the upper part of the cans, where the opening for consumption is located. Said condition is common due to the geometric shape of the upper section that is manufactured through stamping, and as a result it has ridges that function as ridges, accumulating dirt, which is difficult to remove, requiring the can to be at least washed under running water.

In extreme cases these contaminating agents may affect the consumer's health that imbibed the liquid from a contaminated can, even more so when it is considered that the vast majority of consumers are negligent to this risk and simply do not clean the can before the consumption of the beverage.

Thinking of solving this inconvenience, several of covers and protective seals were proposed, the most relevant of which will be briefly commented following.

The Brazilian patent cases BRMU 8301816-6, BRMU 8303346-7 and BRMU 8501669-1 refer to beverage can protectors made up of a polymeric material placed on the upper section of the can so as to completely seal the upper section of the can against the entry of dirt and contaminating agents. All of the protectors mentioned in this document encompass sections of the seal fitted with weakened, breakable lines to enable its removal from the can.

German patent case DE 43 13 3752 refers to a beverage can protector made from plastic material (transparent or colored) with a reduced thickness. The protector has a seal that enables the easy opening of it to consume the beverage in the can, on pulling on a tab shaped puller. The protector is attached to the can by means of an adhesive.

International patent case WO 01/15990 refers to a hermetically sealed protector manufactured from aluminum or some other material, adapted to hygienically protect the upper section of a beverage can, having the same profile as it. Besides its protection against dirt, the protector may be replaced, enabling thus (at least in theory) the retaining of the gas in the case of a partial consumption of carbonated beverage.

The North American U.S. Pat. No. 6,073,797 refers to a hygienic protector for cans fitted with an upper section and a side section. The upper section has an opening and the side section extends downwards in a circle, from the upper section. Once the upper section is opened a tubular extension is provided that seals the opening of the can.

When this protector is installed on a can, the tubular extension forces the tab on the can, opening it at the same time as completely sealing the opening and preventing the liquid coming from inside the can from touching its upper section, thus avoiding eventual contamination.

The North American U.S. Pat. No. 5,452,818 refers to a reusable cover to be placed on beverage cans. This deals with a single piece protector, designated to close and maintain the pressure inside a beverage can after it has been opened. For this purpose it is fitted with a flange that cooperates with the side wall end on its upper section, thus preventing the release of gas via that route, at the same time protecting the can from dirt and contaminants entering it.

Japanese patent case JP 3-148492 refers to a beverage can protector made up of a heat shrinkable material and fitted with a flange that cooperates with the upper section of the can. The protector also encompasses an external tab that protects the inclined upper section of the can, just in the locations where people put their mouths to imbibe the liquid inside. The document also reveals the process for placing the protector on the can.

Greek patent case GR 1004381 refers to a beverage can protector designated to prevent the evaporation of the beverage and to protect the upper section of the can against contaminating agents and dirt. The protector may be made from a polymeric material and encompasses a sealing method with the upper section of the can and a handling tab for its removal.

The North American U.S. Pat. No. 5,139,163 refers to a hygienic protector for beverage cans made up of an annular body and a pivotal lid, joined to the body by means of a weakened line equipped with a puller. Before being opened its protection against dirt is complete. When one wishes to consume the liquid from the can, one just has to pull the tab and break the weakened line, and removing it. Thus the body and lid remain joined by means of a small hinge, enabling it to pivot; access to the upper section of the can up to this moment will be free from contaminants.

The North American U.S. Pat. No. 6,443,323 refers to a can protector made up of a very thin film, metallic or polymeric, placed over the upper section of the can, with the purpose of protecting it against dirt and contaminating agents.

Finally, the North American U.S. Pat. No. 5,346,088 refers to a reusable beverage can protector adapted to hermetically seal the top of the can, including maintaining the beverage's gas after it has been opened. The protector encompasses an external structure and an internal elastomeric member adapted to shape to the can's upper section, forming an effective liquid and gas seal as well as the entry of dirt or contaminants.

### OBJECTIVES OF THE INVENTION

The purpose of this invention is a temperature indicating device to be used on containers holding beverage, with a low added cost to the container, which will enable the clear display of the temperature which it is at, giving a chance for the beverage to be consumed at the most adequate temperature possible.

This invention also has as its objective a temperature indicator device to be used on beverage containers that as an additional function-allows for the protection of the supper section of the container against dirt.

Additionally this invention has as its objective a temperature indicator device to be used on beverage containers that also has the means to indicate the undue opening of the tin.

Also, this invention has as its objective a temperature beverage indicator which is biodegradable.

Finally, this invention also has as its objective a beverage container, shaped particularly in the shape of a metallic can, fitted with a temperature indicator device as described above.

### A BRIEF DESCRIPTION OF THE INVENTION

The objectives of this invention are achieved by a temperature indicator device to be used on beverage containers having a first portion substantially circular from which a second section is projected in a substantially annular format, the first section and/or second section having at least a locking means for the device onto the container, with at least one of the first or second sections being made up of a thermal sensitive material.

Also, the objectives of the current invention are achieved by a temperature indicating device to be used on beverage containers, having a first portion substantially circular from which a second section is projected in a substantially annular format, the first section and/or second section having at least a means for locking the device on the container, with at least one of the first or second sections made up of a biodegradable material.

Finally, the objectives of this invention are achieved by a container holding beverage that includes a device indicating the temperature as defined above.

### A SUMMARIZED DESCRIPTION OF THE DRAWINGS

This invention will be as follows described in further details based on an example as represented in the drawings. The figures show:

FIG. 1—is a view in perspective of two units of the beverage container fitted with the temperature indicator, object of this invention.

FIG. 2—is a view in perspective of the first variation of the temperature indicator device.

FIG. 3—is a view from the top of the first variation of the temperature indicator device.

FIG. 4—is a first view from the side of the first variation of the temperature indicator device.

FIG. 5—is a second view from the side of the first variation of the temperature indicator device.

FIG. 6—is a cross section view of the first variation of the temperature indicator device.

FIG. 7—is a view in perspective of a second variation of the temperature indicator device.

FIG. 8—is a view from the top of the second variation of the temperature indicator device.

FIG. 9—is a side view of the second variation of the temperature indicator device.

FIG. 10—is a view in perspective of a third variation of the temperature indicator device.

FIG. 11—is a view from the top of the third variation of the temperature indicator device.

FIG. 12—is a side view of the third variation of the temperature indicator device.

FIG. 13—is a view in perspective of a fourth variation of the temperature indicator device.

FIG. 14—is a view from the top of the fourth variation of the temperature indicator device.

FIG. 15—is a first side view of the fourth variation of the temperature indicator device.

FIG. 16—is a second side view of the fourth variation of the temperature indicator device.

FIG. 17—is a side view of a fifth variation of the temperature indicator device.

FIG. 18—is the first cross section detailed view of the fifth variation of the temperature indicator device.

FIG. 19—is a view in perspective of the fifth variation of the temperature indicator device.

FIG. 20—is a second schematic perspective view of the fifth variation of the temperature indicator device.

FIG. 21—is a second cross section detailed view of the fifth variation of the temperature indicator device.

### A DETAILED DESCRIPTION OF THE INCENTION

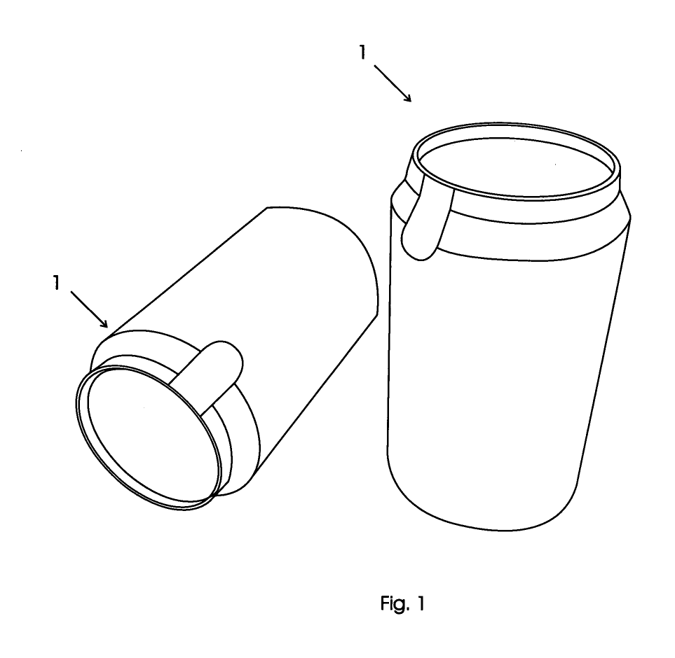

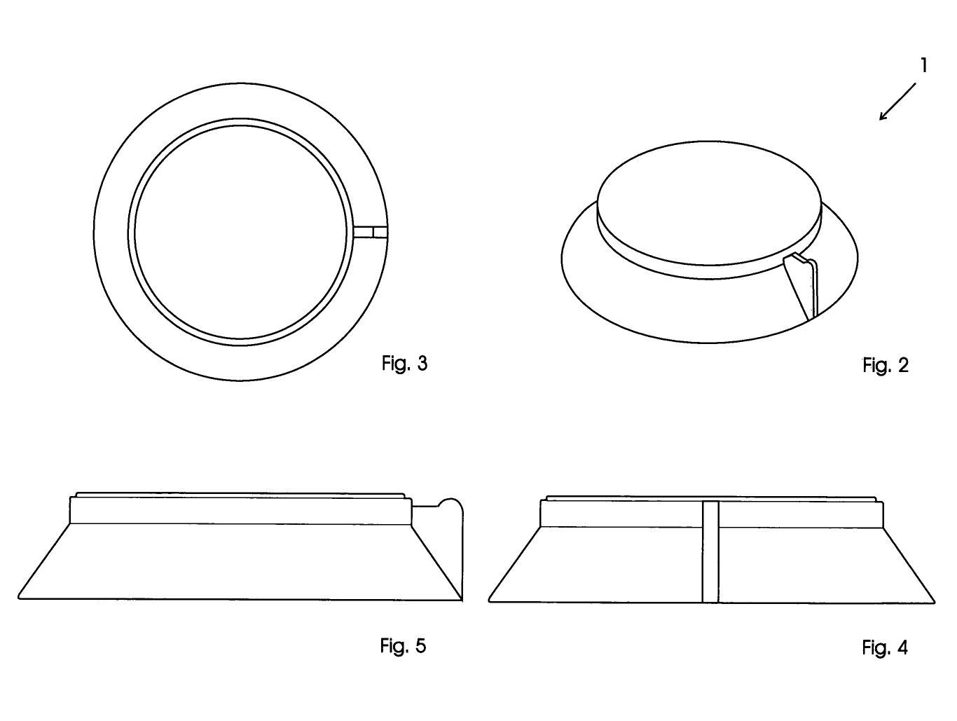

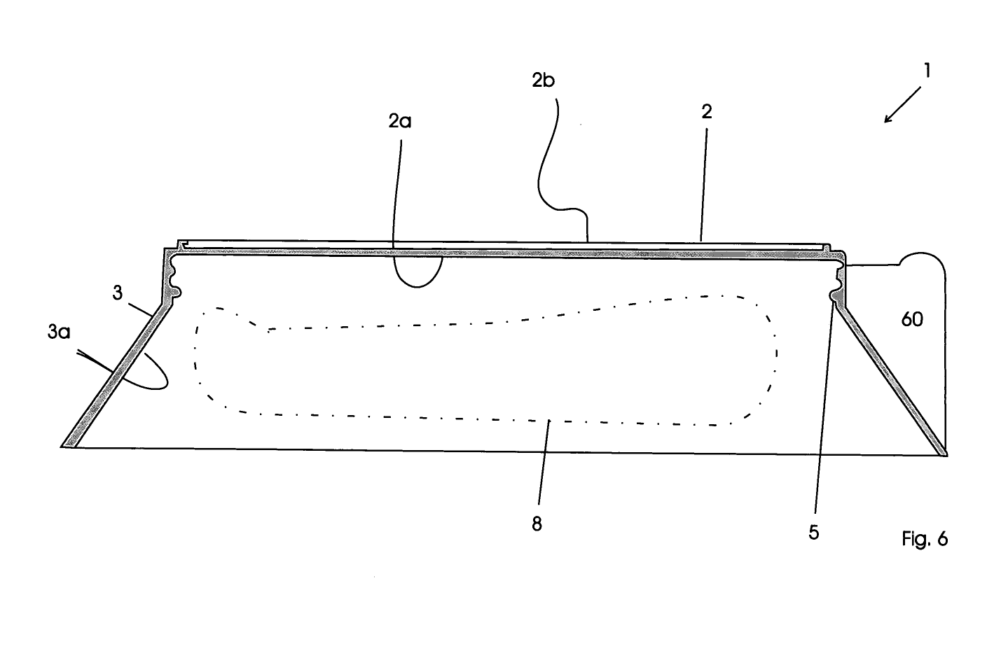

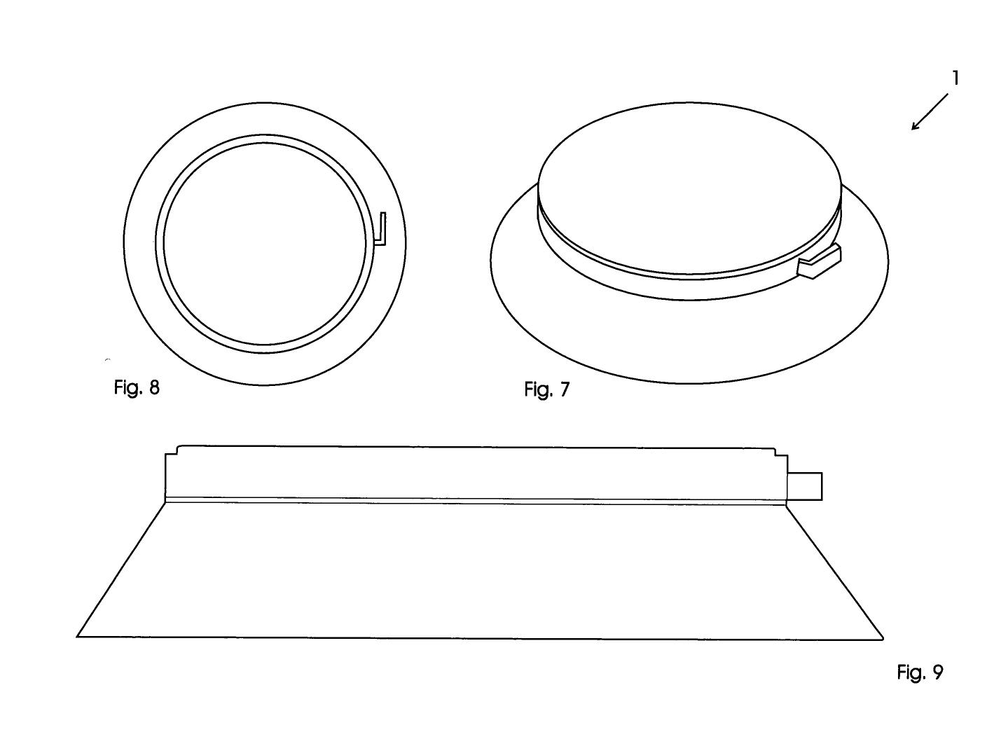

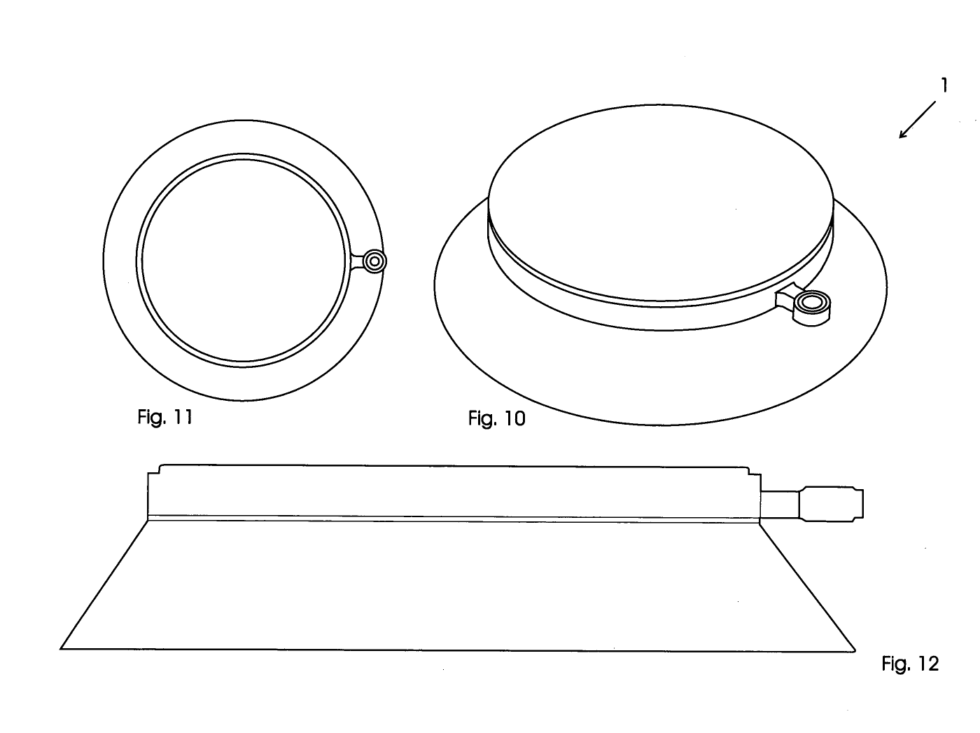

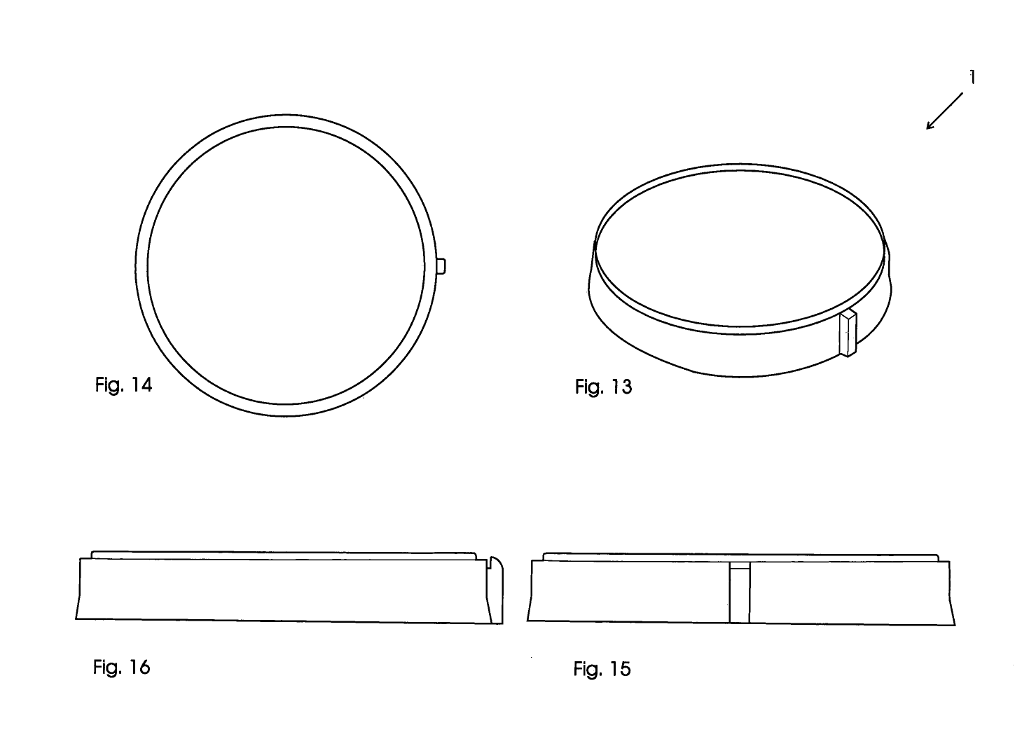

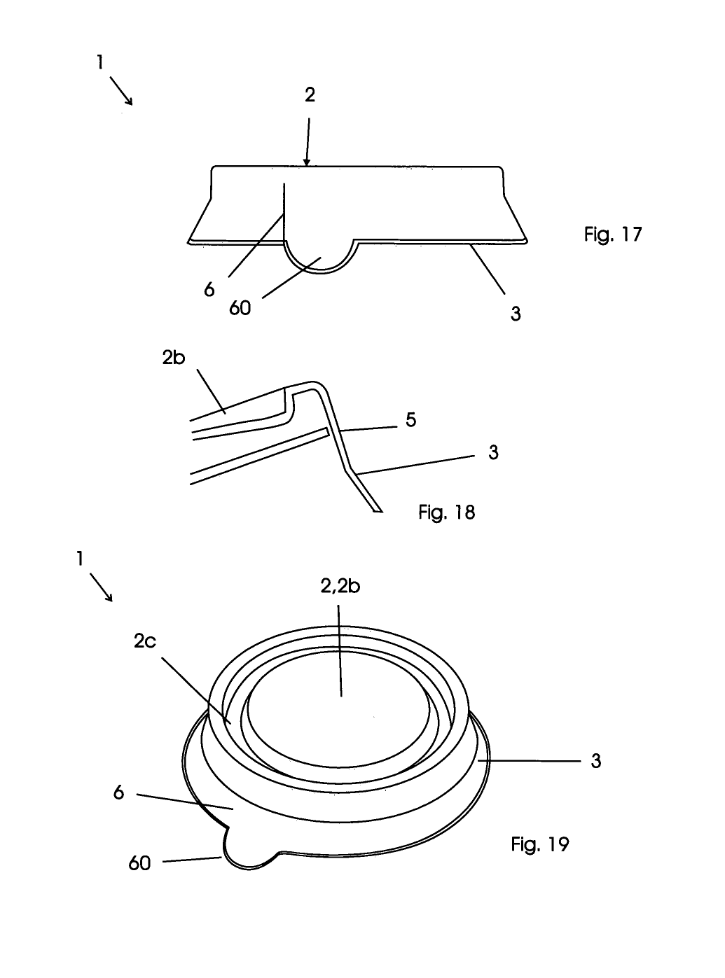

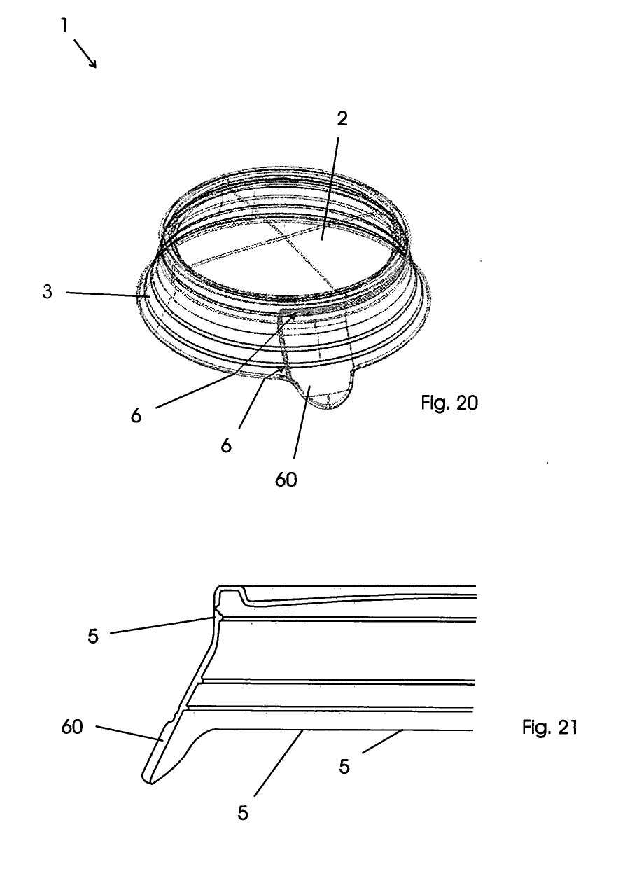

According to a preferred embodiment, and as may be seen in FIG. 1, this invention refers to a temperature indicating device 1 to be used on containers 4 for holding beverages having the characteristics of being thermo sensitive and biodegradable.

Preferably, the device 1 is ideal to be used on beverage cans of various shapes and beverages such as: beer, sodas, energetic drinks, isotonic beverages, juices, teas, vodkas and various other beverage, among others, but it is evident that it may be used on any other type container, if necessary or desirable.

Constructively speaking, the device 1 has a first section that is substantially circular 2 from which a second section that is substantially annular 3 is projected. The first section defines a first internal surface 2a, facing the upper section of the can (where the fragile opening is to be found to consume the beverage) and a second opposing surface 2b, aimed at the mid exterior where optionally publicity may be placed, information on the beverage, drawings, printing, etc.

Optionally, the first section 2 comprises a circular channel 2c which enables the stacking of cans fitted with device 1.

The second annular section 3, in its turn, defines the internal surface 3a facing the can's side wall and a fourth surface, opposite to the first one, facing the mid exterior, which may optionally include grooves for holding and at least a tab to remove the seal (this will be mentioned further on). To correctly cooperate with the can, projection 3 may present a substantially cylindrical projection; a barrel shaped projection or any other, as long as it is operational.

The space defined by the first internal surface 2a of the first circular 2 section and the third internal 3a surface of the second annular 3 section corresponds to a cavity 8.

By being of preference shaped with injected plastic, in reality the circular and cylindrical 2, 3 sections are a single piece.

In a preferential manner, at least one means 5 to lock the device 1 on the upper part of the can is provided, which preferably presents the shape of an annular projection. More preferably, the number of annular 5 projections is between one and three, and even preferably, there is a single projection 5. This annular 5 projection cooperates with an existing annular projection on the cans (as a result of the attaching the upper section of the can to its sidewall), correctly locking the device 1 in place.

In a preferential manner, the annular 5 projection is located on the third internal 3a surface of the second annular 3 section, but it is evident that the said configuration may vary.

It is feasible a device 1 in which the single annular projection 5 is located on the first internal 2a surface of the first circular 2 section or, even, a device fitted with two or more annular 5 projections, both located on the first surface 2a, both on the third surface 3a, or even at least one projection 5 placed on each surface. The number and placing of the annular 5 projections are indifferent in the definition of the scope for protecting the current invention, as long as the device 1 remains firmly attached to the can.

When device 1 is correctly positioned, the cavity 8 perfectly holds the upper section of the can, even more so because the second annular 3 section acts as a skirt, protecting the side of the can, adjacently to its upper section (which is where the consumer places their mouth to beverage), against the entry of dirt and contaminants. As a result, it is very unlikely for the consumer to come into contact with some undesirable contaminant.

In order to increase the guarantee of safety of the can and the consumer, the device 1 additionally encompasses a seal 6, made up of at least one fragile line, making lighter and visible the violation of is device 1, and if it is the case, the opening of the can, conditions under which the protection against dirt could no longer be guaranteed. In other words, the breaking of the seal 6 is an indication that the region of the cavity 8 may have been exposed to dirt and contaminants and that the seal against this type of substance may no longer be guaranteed.

The placing of seal 6 may assume any necessary or desirable configuration, since this is not the objective of the invention, and preferably a tab 60 is provided. When pulling the tab 60, the consumer may remove the device 1 and consume the beverage contained inside the can. It is important to mention that the breaking of the seal 6 renders the device 1 useless and may no longer be reused, causing it to be discarded.

Nevertheless, it is perfectly possible to develop a device 1, which may be reused without applying the seal 6, for example, since the protection conferred by these claims does not focus on these characteristics.

The main innovation of the device 1, in fact, does not take place in its physical makeup or performance with respect to its capacity to prevent the entry of dirt into the cavity 8, something that is successfully achieved by other known products.

The innovative difference of this invention results from the fact that device 1 has at least one of the first or second sections 2, 3 made up of a thermo sensitive material, and, also is preferably made of a biodegradable material, reducing severely the environmental impact resulting from its disposal after consuming the beverage.

The use of the thermo sensitive material gives to device 1, without prejudicing its other properties, the ability to inform the consumer with reasonable precision if the beverage is at a suitable or adequate temperature for consumption.

In this respect, it is noteworthy that, especially in the case of beer, the choice of temperature is important so that one may enjoy the beverage's flavor and consistency. Beer when it is minimally chilled or over chiller looses considerably its flavor, becoming ‘flat’ or excessively bitter, if over chilled, presenting small crystals that makes its texture very unappealing.

The question of the beer's temperature for consumption is so important that pubs, restaurants and supermarkets store the beer in refrigerators fitted with thermometers (in most cases they are digital and easy to see from a distance) to guarantee consumers that the beverage is to be found at the optimum temperature for consumption.

However, most of the cases this resource is not available at home or at small commercial establishments, locations where the beer's temperature must be checked manually, by holding the can, which is a very imprecise method.

Device 1, the object of this invention, gracefully remedies this inconvenience, once as mentioned it is made of a thermo sensitive material. This material changes color resulting from the temperature at which it is found, more technically called a thermochromic material.

More specifically, the thermochromic material changes its color when a given temperature is lower than in relation to the ambient temperature. When the temperature increases the color that had appeared vanishes and therefore it is guaranteed that the change in the color of device 1 will only occur after a given reduced consumption temperature is reached (as inside a freezer or refrigerator, for example).

In a preferential manner, thermochromic dyes are used, which are based on leuco dye mixtures with other chemical compositions, presenting a change in coloring as a result of the temperature.

The Thermochromic dyes are rarely used directly, with its use being more common in the form of microcapsules inside which is contained a mixture of products.

In the case of this invention microcapsules with crystal violet lactone and a weak acid may be used.

Another alternative is to use spirolactones, fluorans, spiropyrans and fulgides. The weak acids include bisphenol A, parabens, 1,2,3-triazole derivates and 4-hydroxycoumarin as a proton donor.

In general, leuco dyes are used in combination with other pigments producing a change in color between the pigment's color, and the color of the combined pigment, with the color of the non-leuco form of the leuco dye. Organic leuco dyes are available in temperature ranges between −5° C. and 60° C., in various tones. The changes in color as a rule take place in a range of around 3° C.

In essence, the thermochromic material comprises a number of capsules with color changing substances in a precise and reversible form, as a result of the temperature to which it is submitted.

Evidently, the device 1 object of this invention may use any type of thermochromic material as is necessary or desirable. But it is important to mention that this material does not migrate from inside these microcapsules and is stable in its color changing function. Finally, the thermochromic material to be used, whatever it may be, is extremely safe to the end consumer as a temperature indicating device for the beverage, without presenting any type of contra-indication.

The thermochromic material is dispersed together with the polymer base that makes up device 1 and both are cast in a manner that it remains dispersed in a substantially homogenous manner in the plastic structure of the final product. Thus, the change in color of device 1 is homogenous.

Without prejudice to the protection scope defined in the claims, the thermochromic material Chromicolor® manufactured by Matsui Intl. Co. Inc., a company located in California, United States, is used, although many others may be used.

The Chromicolor® material is very accurate in indicating the temperature, and it behaves according to the chart as stated in the following table, supplied by the manufacturer:

Chromicolor ®

| Product | Color | Color | Color | Color |
|---|---|---|---|---|
| classification | appearance | appears | disappears | disappears |
| (type) | below (° C.) | below (° F.) | over (° C.) | over (° F.) |
| 025 | −25 | −13 | −15 | 5 |
| 015 | −13 | 8.6 | 0 | 32 |
| 07 | −4 | 24.8 | 5 | 41 |
| 5 | 1 | 22.8 | 12 | 53.6 |
| 8 | 5 | 41 | 14 | 57.2 |
| 10 | 8 | 46.4 | 16 | 60.8 |
| 15 | 11 | 51.8 | 19 | 66.2 |
| 17 | 14 | 57.2 | 23 | 73.4 |
| 20 | 16 | 60.8 | 26 | 78.8 |
| 22 | 20 | 68 | 29 | 84.2 |
| 25 | 22 | 71.6 | 31 | 87.8 |
| 27 | 24 | 75.2 | 33 | 91.4 |
| 30 | 25 | 77 | 35 | 95 |
| 35 | 27 | 80.6 | 36 | 96.8 |
| 37 | 32 | 89.6 | 41 | 105.8 |
| 41 | 35 | 95 | 44 | 111.2 |
| 45 | 40 | 104 | 50 | 122 |
| 47 | 44 | 111.2 | 58 | 136.4 |
| 60 | 53 | 127.4 | 65 | 149 |

Therefore, it is necessary a certain temperature range for a complete change in color to take place. As an example, Chromicolor® type 25 displays 100% of its color at temperatures from 22° C. or lower and this color starts to disappear in the range between 22° C. and 31° C., gradually, with the increase in temperature. Over 31° C., the color disappears completely.

Evidently, the classification (type) of Chromicolor® to be used will depend on the type of beverage to be packed in the can. If for example, the can is holding a beverage for which the optimum temperature to be consumed is −2° C., then Chromicolor® type ‘5’ will be used.

It is therefore clear that there is no clear preference to this invention. On the contrary, device 1 object of this invention may have as many compositions as there are products packed in cans that are fitted with it. It may be for example that a certain type of device 1 may be used for beer cans, another type of device 1 destined to soda cans, and so on.

In the same manner and as a result of the type of thermochromic material used, one may obtain sensitive color variations. For example, for devices destined for red colored cans (for example, Coca-Cola® cans), the colorant inside the microcapsules may be red in color, and so on. In this manner one obtains an esthetically more interesting effect which will be seen when the can reaches the given temperature from which the coloring of device 1 starts to change.

It is, also, possible to contrast the color of the thermochromic material to the polymeric base material on device 1, thus obtaining very interesting visual effects, making it clear that the given ideal temperature for consuming the beverage has been attained.

Finally, it is worth to note that the more thermochromic material that is added to the polymer the more intense will be the change in coloring with a reduction in temperature, increasing the technically advantageous effect of device 1.

As has been mentioned, device 1 is manufactured from polymeric material that may present the most different of configurations.

Without prejudicing the scope of protection as define in the claims, and of preference low density polyethylene is used UB1975®, as supplied by the company Polietilenos Uniäo, in Santo André-SP-Brazil.

Another preferential characteristic is that the polymer making up device 1 is biodegradable and easy to recycle (ecologically correct), in a way reducing the environmental impact arising from its disposal after the can has been opened, keeping in view that it is not reusable after the seal 6 has been broken.

Preferably, the polymer which constitutes the device 1 contains around 97% of a polymeric matrix and around 3% of additive, although this proportion may still be lower, using even less additive without the resulting product loosing its desirable biodegradable characteristic.

Explaining in a simplified manner, the additive reduces the size and weight of the molecular chains of common plastic (polyethylene, polypropylene, BOPP, PET, OS, among others) and breaks the links between the carbon and hydrogen molecules that make up the plastic, which causes the material to start breaking down under common existing conditions in the environment where it is to be discarded as waste. After breakdown, the small resulting fragments will be more easily digested by the bacteria and fungus existing in nature.

The resulting film deteriorates through the action of microorganisms in contact with the soil, in contact with organic residues in composting environments at refuse dumps, over a period of 40 to 120 days, being trans-formed into organic compost that may be used as humus in composting. The decomposition time may also be adjusted according to the purpose of the product.

Once the existing links between the carbon and hydrogen atoms are broken down in the added plastic, these atoms will link to the oxygen atoms existing in the atmosphere, resulting in carbon dioxide and water, the same substances the living beings exhale during breathing.

These properties do not change any of the original desirable characteristics of the ordinary plastic. The final added products are fully recyclable.

This is a new and inventive invention, included in the protection scope of the stated claims, a container holding beverage, that includes a temperature 1 indicating device here described.

With preferred examples having been described, it must be understood that the scope of this invention covers other possible variations, only being limited by the contents of the claims herein made, including the possible equivalents.

1. Temperature indicating device to be used on beverage containers, having a substantially circular first section from which a second substantially annular section projects, the first section and/or the second section having at least one means to lock the devices onto the containers, the device being characterized in that at least one of the first and second sections is made up of a thermo sensitive material.

2. The device according to claim 1, wherein the means for locking the device onto the container is an annular projection from the first section.

3. The device according to claim 1, wherein the means for locking the device onto the container is an annular projection from the second section.

4. The device according to claim 1, wherein the second section has a cylindrical shaped projection.

5. The device according to claim 1, wherein the second section has a barrel shaped projection.

6. The device according to claim 1, further comprising at least one sealing element indicating that the container has been opened.

7. The device according to claim 1, wherein the thermo sensitive material includes a number of capsules containing substances that change color in a precise and reversible manner as a result of the temperatures to which it is submitted.

8. The device according to claim 1, wherein the thermo sensitive material undergoes color changes as a result of its temperature.

9. A temperature indicating device to be used on containers holding beverage, having a substantially circular first section from which a second section substantially annular in shape projects, the first section and/or the second section having at least a means to lock the device on the containers, the device characterized in that at least one of the first and second sections is composed of a biodegradable material.

10. A container holding beverage, comprising a device as defined in claim 1.
